(19) United States
(12) Patent Application Publication
(10) Pub. No.: US 2016/0070518 A1
(43) Pub. Date: Mar. 10, 2016

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Akira SAITO, Mishima Shizuoka (JP)

(21) Appl. No.: 14/824,816

(22) Filed: Aug. 12, 2015

(30) Foreign Application Priority Data
Sep. 6, 2014 (JP) 2014-181803

(51) Int. Cl. G06F 3/12

(52) U.S. Cl. CPC G06F 3/1263; G06F 3/1205; G06F 3/1207; G06F 3/1258

(57) ABSTRACT

According to an embodiment, an image forming apparatus includes an image forming unit, a memory, an operation panel, and a processor. The memory stores a plurality of printing jobs not yet executed. The operation panel accepts a selection of a plurality of printing jobs to be executed and a designation of a printing order of the selected printing jobs. The processor causes the image forming unit to execute the plurality of selected printing jobs in the designated printing order.

### CROSS-REFERENCE TO RELATED APPLICATIONS

This application is based upon and claims the benefit of priority from the prior Japanese Patent Application No. 2014-181803, filed on Sep. 6, 2014, the entire contents of which are incorporated herein by reference.

### FIELD

An embodiment described herein is generally related to an image forming apparatus and an image forming method.

### BACKGROUND

There are image forming apparatuses that have functions called private printing and hold printing. The private printing and hold printing are functions of an image forming apparatus for accumulating printing requests from an external apparatus as printing jobs and executing printing in response to a user operation made via an operation panel. In the image forming apparatus of the related art, when a user collectively selects a plurality of accumulated printing jobs, he cannot set a printing order of the printing jobs freely. Further, in the image forming apparatus of the related art, with an arbitrary combination of a plurality of different printing jobs being one set, it is impossible to designate the printing order of the printing jobs in a set unit and print them.

### BRIEF DESCRIPTION OF THE DRAWINGS

FIG. 1 is a block diagram schematically showing an image forming apparatus according to a first embodiment.

FIG. 2 is a diagram for schematically explaining hold printing processing that is executed by the image forming apparatus according to the first embodiment.

FIG. 3 is a display example of a hold printing job selection screen in the image forming apparatus according to the first embodiment.

FIG. 4 is a display example of the hold printing job selection screen in the image forming apparatus according to the first embodiment.

FIG. 5 is a display example of a printing order setting screen in the image forming apparatus according to the first embodiment.

FIG. 6 is a display example of the printing order setting screen in the image forming apparatus according to the first embodiment.

FIG. 7 is a display example of the printing order setting screen in the image forming apparatus according to the first embodiment.

FIG. 8 is a display example of the printing order setting screen in the image forming apparatus according to the first embodiment.

FIG. 9 is a diagram showing a result of sequentially printing three sets of printing jobs, each set including three printing jobs, in the image forming apparatus according to the first embodiment.

FIG. 10 is a flowchart for explaining the hold printing job processing that is executed by the image forming apparatus according to the first embodiment.

### DETAILED DESCRIPTION

According to one embodiment, there is provided an image forming apparatus including an image forming unit, a memory, an operation panel, and a processor.

The image forming unit executes a printing job by forming an image on a recording medium.

The memory stores a plurality of printing jobs not yet executed by the image forming unit.

The operation panel accepts a selection of printing jobs to be executed from the plurality of printing jobs stored in the memory and a designation of an execution order of the selected printing jobs.

The processor causes the image forming unit to execute the printing jobs selected via the operation panel in the execution order designated via the operation panel.

Hereinafter, the embodiment will additionally be described with reference to the drawings. In the figures, the same reference numerals denote the same or similar parts.

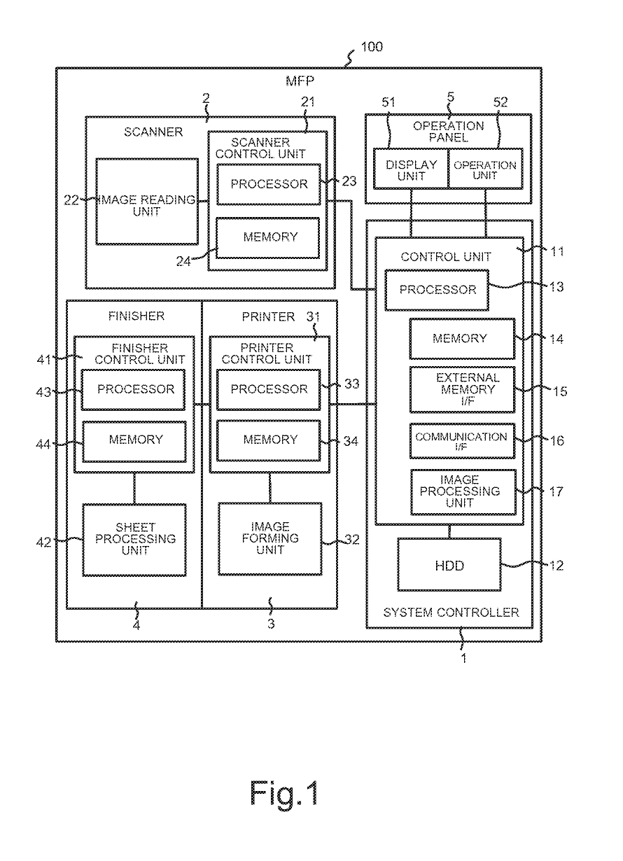

FIG. 1 is a block diagram schematically showing an image forming apparatus according to the embodiment. The image forming apparatus of this embodiment is, for example, an MFP (Multi-Functional Peripheral). As shown in FIG. 1, a digital multi-functional peripheral as an MFP 100 includes a system controller 1, a scanner 2, a printer 3, a finisher 4, and an operation panel 5.

The system controller 1 collectively controls the respective units of the MFP 100. The system controller 1 includes a control unit 11 and an HDD 12. The control unit includes a control board (system control board). The control board of the control unit 11 includes a processor 13, a memory 14, an external memory I/F 15, a communication I/F 16, and an image processing unit 17.

The processor 13 carries out overall control of the MFP 100, data processing, and the like and is, for example, a CPU. The processor 13 carries out various types of processing by executing programs stored in the memory 14. The memory 14 includes a RAM, a ROM, and an EEPROM. The external memory I/F 15 is an interface to which an external memory is connected. The communication I/F 16 is an interface for performing communication with an external apparatus via a network and the like. The image processing unit 17 is a processing unit that carries out data conversion (file conversion) processing and the like.

The scanner 2 is a processing unit that reads an image in a script and converts it into image data. The scanner 2 includes a scanner control unit 21 and an image reading unit 22. The scanner control unit 21 controls operations of the image reading unit 22. The scanner control unit 21 includes a control board. The control board of the scanner control unit 21 includes a processor 23 and a memory 24.

The processor 23 is connected to the control unit 11 of the system controller 1 via an interface. The processor 23 carries out various types of processing of the scanner 2 by executing programs stored in the memory 24. For example, the processor 23 reads an image in a script by the image reading unit 22 based on an instruction from the system controller 1 and acquires image data of the script. The processor 23 outputs the acquired image data to the system controller 1.

The image reading unit 22 converts an image on a reading surface of a script sheet into image data. The image reading unit 22 includes a CCD line sensor. The image reading unit 22 may scan a script sheet placed on a script table glass or may read an image on a script sheet carried by an ADF (Auto Document Feeder).

The printer 3 is a processing unit that forms an image on a printing sheet as a recording medium. The printer 3 includes a printer control unit 31 and an image forming unit 32. The printer control unit 31 controls the image forming unit 32. The printer control unit 31 includes a control board. The control board of the printer control unit 31 includes a processor 33 and a memory 34. The processor 33 of the printer control unit 31 is connected to the control unit of the system controller 1 via an interface. The processor 33 carries out various types of processing of the printer 3 by executing programs stored in the memory 34. For example, the processor 33 controls the image forming unit 32 based on an instruction from the system controller 1 to form an image on a printing sheet.

The image forming unit 32 forms a monochrome or color image on a printing sheet. The image forming method executed by the image forming unit 32 is not limited to a particular method. For example, the image forming unit 32 may form an image using an electronic photograph method, an inkjet method, or a thermal transfer method.

The finisher 4 is a processing unit that carries out finishing processing on a sheet discharged after an image is printed thereon by the printer 3. The finisher 4 includes a finisher control unit 41 and a sheet processing unit 42. The finisher control unit 41 includes a control board. The control board of the finisher control unit 41 includes a processor 43 and a memory 44. The processor 43 of the finisher control unit 41 is connected to the printer control unit 31 via an interface. The processor 43 carries out various types of processing of the finisher 4 by executing programs stored in the memory 44. The sheet processing unit 42 carries out processing of sorting, stapling, and the like as the finishing processing on a sheet discharged from the printer 3.

The operation panel 5 is a user interface. The operation panel 5 includes a display unit 51 and an operation unit 52. The display unit 51 and the operation unit 52 are connected to the control unit 11 of the system controller 1. The display unit 51 includes a liquid crystal display apparatus (LCD) equipped with a backlight. The operation unit 52 includes a touch panel and hard keys. For example, the display unit 51 and the operation unit 52 may be constituted of a liquid crystal display apparatus including a touch panel.

Next, hold printing and private printing in the MFP 100 of this embodiment will be described.

The MFP 100 includes a hold printing function and a private printing function. The hold printing function and the private printing function are functions for executing printing jobs that the MFP 100 receives from the external apparatus, according to execution instructions from a user made via the operation panel. Specifically, the MFP 100 accumulates, as the printing jobs, a hold printing request and a private printing request received from the external apparatus. The MFP 100 accepts the execution instructions for the printing jobs from the user via the operation panel. Based on the accepted execution instructions from the user, the MFP 100 executes the printing jobs. It should be noted that the private printing is a printing function that requires a user authentication based on authentication information such as a password for executing printing. For example, the MFP 100 accepts an input of authentication information from the user via the operation panel. Based on the accepted authentication information, the MFP 100 identifies the user. When the user is identified, the MFP 100 permits the user to input an execution instruction for the printing job. On the other hand, the hold printing is a printing function that does not require the user authentication. Hereinafter, an operation example of the MFP 100 when performing the hold printing will be described, but operations of the private printing carried out by the MFP 100 excluding the user authentication are the same as those of the hold printing.

For example, the control unit 11 of the system controller 1 receives a hold printing request from the external apparatus via the communication I/F 16. The hold printing request includes printing data. Upon receiving the hold printing request, the control unit 11 accumulates the received printing request in the HDD 12 as a hold printing job (hereinafter, simply referred to as printing job). The control unit 11 executes a printing job selected by the user via the operation unit 52 of the operation panel 5 out of the accumulated printing jobs. In other words, the HDD 12 accumulates printing jobs not yet executed.

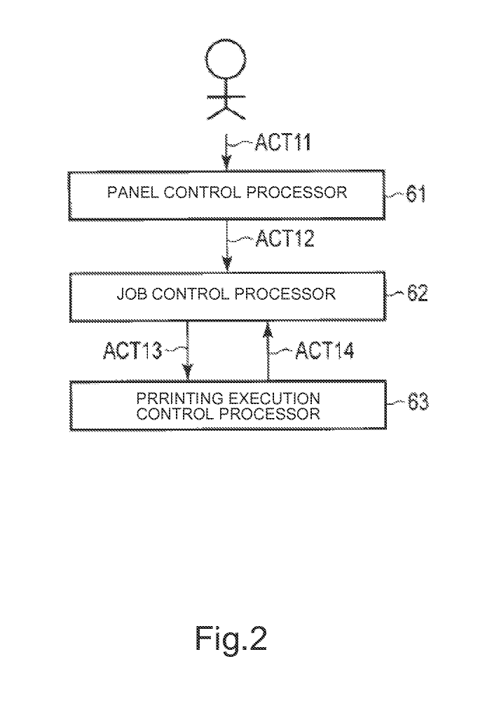

FIG. 2 is a diagram for schematically explaining the processing of executing the hold printing by the MFP 100. The processor 13 of the control unit 11 carries out the hold printing processing based on the program stored in the memory 14. Specifically, the processor 13 executes the program to function as a panel control processor 61, a job control processor 62, and a printing execution control processor 63 as shown in FIG. 2.

The user transmits, for example, at least one hold printing request to the MFP 100 from the external apparatus such as a user terminal.

The control unit 11 of the system controller 1 accumulates the hold printing request from the external apparatus as a printing job.

The user who has transmitted the hold printing request operates the operation unit 52 of the operation panel 5 to select the hold printing function.

Specifically, the panel control processor 61 displays, on the display unit 51, an operation screen on which the hold printing function can be selected.

The panel control processor 61 also displays, on the operation screen, a selection button used for selecting the hold printing function. The panel control processor 61 detects a selection of the hold printing function by the user via the selection button.

As the panel control processor 61 detects the selection of the hold printing function, the control unit 11 carries out processing of a selection of a printing job to be executed, a printing setting, and the like. The printing setting includes settings of an execution order of the printing jobs (printing order), the number of sets to be printed, and the like.

Specifically, as shown in ACT11 of FIG. 2, the panel control processor 61 accepts a selection of the user on the printing job to be executed via the operation panel 5. The panel control processor 61 also accepts a printing setting of the selected printing job via the operation panel 5. For example, the user operates the operation panel 5 to select a plurality of printing jobs. Next, the user sets a printing order etc. of the plurality of selected printing jobs by operating the operation panel 5. As shown in ACT12 of FIG. 2, the panel control processor 61 outputs the plurality of selected printing jobs and the printing setting thereof to the job control processor 62.

For executing the plurality of output printing jobs according to the output printing setting, the job control processor 62 outputs a printing execution instruction including the printing jobs and the printing setting to the printing execution control processor 63 as shown in ACT13 of FIG. 2. For example, the job control processor 62 may output, to the printing execution control processor 63, the printing execution instruction for the printing jobs one set at a time in the printing order included in the printing setting. When outputting the printing execution instruction for the printing jobs one set at a time, the job control processor 62 repetitively outputs the printing execution instruction for the printing jobs until printing of all sets is completed.

By controlling the printer 3 based on the printing execution instruction from the job control processor 62, the printing execution control processor 63 executes the printing based on the printing jobs according to the printing setting. Upon completing the printing of the plurality of hold printing jobs, the printing execution control processor 63 outputs a printing completion to the job control processor 62 as shown in ACT14 of FIG. 2. The job control processor 62 recognizes the printing completion of the printing jobs upon receiving the output of the printing completion from the printing execution control processor 63.

More specifically, the user operates a start button on the operation panel 5 after performing the printing setting, for example. Upon accepting the operation on the start button by the user via the operation panel 5, the panel control processor 61 determines the printing setting such as the printing order. The panel control processor 61 creates a job ID list in which job IDs of the printing jobs are arranged in the determined printing order. The job ID is data for specifying each printing job. In ACT12, the panel control processor 61 outputs the job ID list to the job control processor 62 together with the printing setting. The printing setting may include information indicating a setting of the finishing processing, that includes a sheet sorting setting in a set unit, in addition to the printing order and the number of printing sets.

In ACT13, the job control processor 62 outputs the printing execution instruction to the printing execution control processor 63 based on the order of the job ID list output from the panel control processor 61. As described above, the job control processor 62 repeats the output of the printing execution instruction in the printing order until reaching the number of printing sets included in the printing setting. The printing execution control processor 63 executes the printing in the order of the printing execution instructions from the job control processor 62.

Further, in ACT13, with a plurality of printing jobs being one set, for example, the job control processor 62 can instruct the printing execution control processor 63 to execute printing of a plurality of sets of printing jobs. When outputting a printing execution instruction for a first printing job in each set to the printing execution control processor 63, the panel control processor 61 outputs, to the printing execution control processor 63, a parameter indicating that the instruction is a printing execution instruction for the first printing job. Also when outputting a printing execution instruction for a last printing job in each set to the printing execution control processor 63, the panel control processor 61 outputs, to the printing execution control processor 63, a parameter indicating that the instruction is a printing execution instruction for the last printing job. The printing execution control processor 63 suspends the finishing processing until receiving the printing execution instruction for the last printing job in the set. Upon receiving the printing execution instruction for the last printing job in the set, the printing execution control processor 63 executes the finishing processing.

Next, an example of the selection of printing jobs and the printing setting of the selected printing jobs on the operation panel 5 will be described in more detail. As the user selects the hold printing function on the operation panel 5, the panel control processor 61 displays a printing job selection screen on the display unit 51. The printing job selection screen is a screen for prompting the user to select a printing job to be executed.

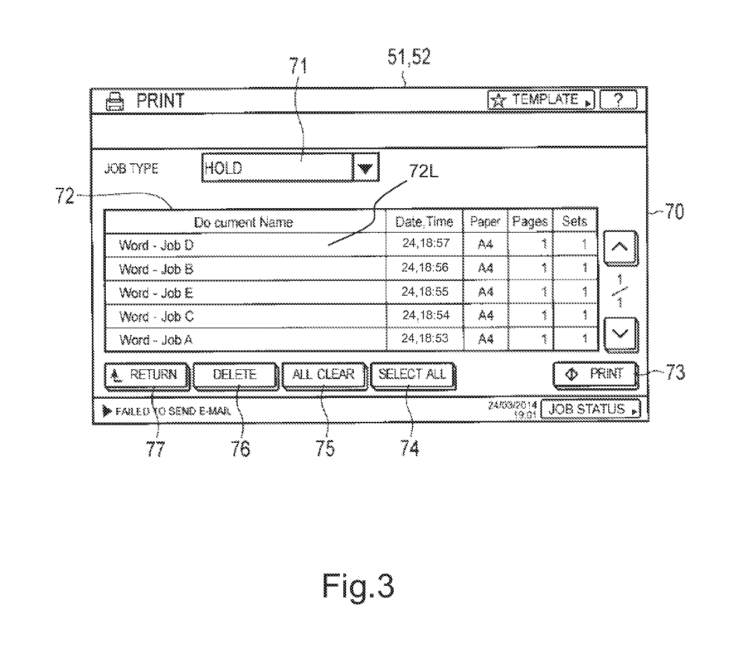

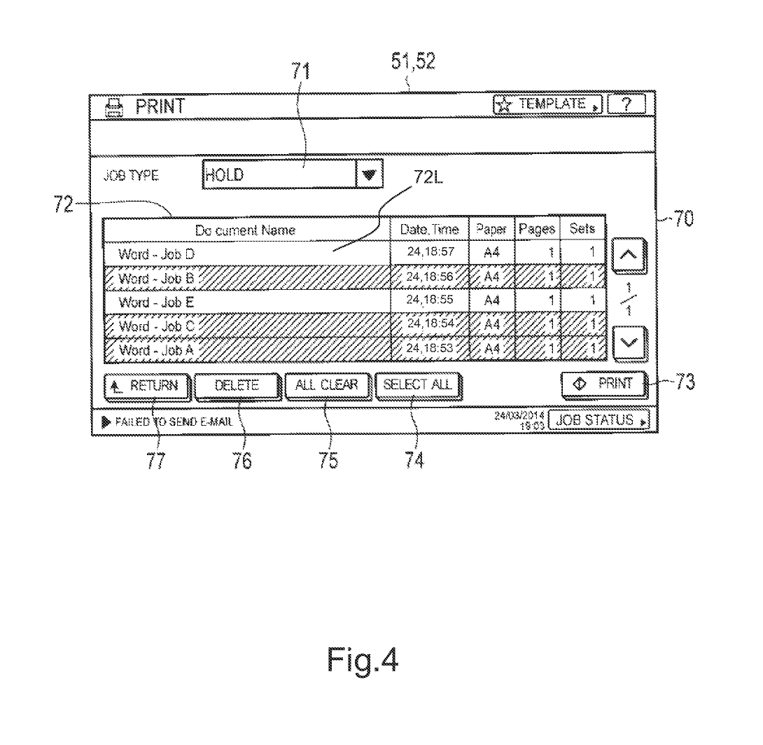

FIGS. 3 and 4 are diagrams each showing the printing job selection screen 70 displayed on the display unit 51 of the operation panel 5. The operation panel 5 includes the display unit 51 and the operation unit 52 as described above. In FIGS. 3 and 4, the display unit 51 includes a touch panel and exerts a function as the operation unit 52. As shown in FIGS. 3 and 4, the printing job selection screen 70 includes a job type display column 71, a printing job list display column 72, a print button 73, a select-all button 74, a select-all clear button 75, a delete button 76, and a return button 77.

The panel control processor 61 controls the display unit 51 to display a type of the printing function selected by the user in the job type display column 71. When displaying the hold printing function as the printing function type, the display unit 51 displays a letter string “HOLD” indicating the hold printing function in the job type display column 71 as shown in FIG. 3, for example. The panel control processor 61 also controls the display unit 51 to display a printing job list 72L in the printing job list display column 72. The printing job list 72L is a list of printing jobs belonging to the job type displayed in the job type display column 71. As shown in FIG. 3, the display unit 51 displays the printing job list 72L in the printing job list display column 72. The panel control processor 61 detects, via the touch panel of the display unit 51, a touch operation of the user with respect to a display part of each printing job in the printing job list 72L. Therefore, the printing jobs in the printing job list 72L can be selected by the user. By detecting the touch operation of the user, the panel control processor 61 accepts the selection of the printing job. The panel control processor 61 highlights the display parts of the selected printing jobs as shown in FIG. 4, for example. By highlighting the display parts of the printing jobs, the panel control processor 61 displays that the printing jobs have been selected.

As shown in the display examples of FIGS. 3 and 4, the display unit 51 displays the printing job list 72L including, for example, 5 printing jobs (jobs A to E), in the printing job list display column 72. The display unit 51 displays, as each printing job, a document name, a time and date, a sheet size, the number of pages, and the number of sets. It should be noted that the time and date is a registration time and date at/on which the printing job is stored in the HDD 12. As shown in FIGS. 3 and 4, the display unit 51 displays the printing jobs in the order of the times and dates, for example. The selection screen 70 shown in FIG. 3 is a display example where all the printing jobs included in the printing job list 72L are not selected. The selection screen 70 shown in FIG. 4 is a display example where 3 printing jobs (Word-Jobs A, B, and C) are selected out of the printing jobs included in the printing job list 72L.

The print button 73 is a button that accepts a user instruction to determine the selected printing jobs and display a setting screen for setting the printing order of the selected printing jobs. For example, when the user touches the print button 73 on the selection screen 70 shown in FIG. 4 in a state where a plurality of printing jobs are selected, the panel control processor 61 detects a touch operation of the user with respect to the display part of the print button 73 via the touch panel of the display unit 51. Upon detecting the touch operation of the user, the panel control processor 61 controls the display unit 51 to display the setting screen for setting the printing order of the printing jobs. Under control of the panel control processor 61, the display unit 51 displays a popup of the setting screen for the printing order (output order), for example.

The select-all button 74 is a button that accepts an instruction of the user to collectively select all the printing jobs displayed in the printing job list 72L. The select-all clear button 75 is a button that accepts an instruction of the user to collectively cancel the selections of all the printing jobs selected in the printing job list 72L. The delete button 76 is a button that accepts an instruction of the user to delete the printing job that is being selected in the printing job list 72L. The return button 77 is a button that accepts an instruction of the user to return to the operation screen a step before the selection screen 70. It should be noted that the display unit 51 may also display, on the selection screen 70, a button (icon) for displaying the setting screen for the printing order in addition to the print button 73.

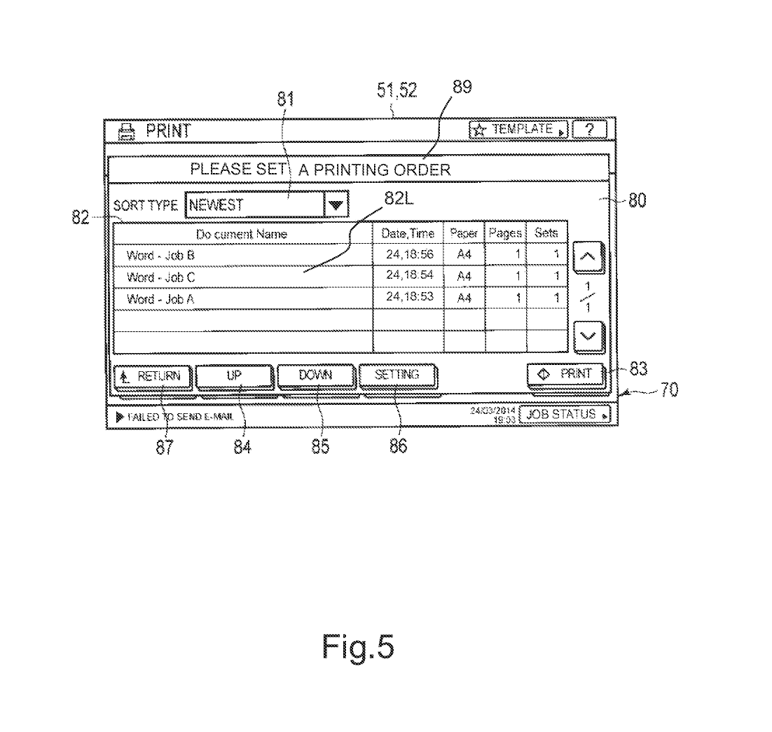

FIGS. 5 to 8 are diagrams showing a setting screen 80 for setting the printing order of the selected printing jobs. Specifically, FIGS. 5 to 8 show the printing order setting screen 80 in a case where, on the selection screen 70, three printing jobs (Word-Jobs A, B, and C) are selected, and the print button 73 is operated by the user. In the setting screen 80 shown in FIGS. 5 to 8, the display order of the printing jobs correspond to the printing order (output order). The panel control processor 61 displays the printing order setting screen 80 shown in FIGS. 5 to 8 as a popup screen on the printing job selection screen 70.

The setting screen 80 includes a message area 89, a sort type display column 81, a printing job list display column 82, a print button 83, an up button 84, a down button 85, a setting button 86, and a return button 87. The message area 89 displays a guide message for the user. For example, as shown in FIG. 5, the message area 89 displays a letter string of “please set a printing order” or the like as the message to the user.

The display unit 51 displays a sort type of a printing job list 82L in the sort type display column 81. The sort type of the printing job list 82L is a method of sorting the printing jobs included in the printing job list 82L. In other words, the sort type is a method of sorting the display order of the printing jobs in the display column 82. The sort type includes a “NEWEST” type of sorting the printing jobs from a newest registration time and date of the printing jobs, for example. In the display column 81 shown in FIG. 5, the “NEWEST” type is displayed as the sort type.

The display unit 51 displays, in the printing job list display column 82, the printing job list 82L in which the display order is sorted according to the sort type displayed in the display column 81. In the display column 82 shown in FIG. 5, three printing jobs are sorted according to the “NEWEST” type and displayed. Here, the three printing jobs are the printing jobs selected on the selection screen 70. As shown in FIG. 5, the sort type display column 81 displays the letter string “NEWEST” indicating the sorting. As shown in FIG. 5, in the printing job list display column 82, the printing jobs are displayed from the newest registration time and date from the top. The sort type displayed in the display column 81 may be set to “NEWEST” as a default, for example. When the sort type is set to “NEWEST” as a default, the panel control processor 61 displays, in the initial screen of the setting screen 80, the printing job list 82L in which the printing jobs are sorted by the arrangement type “NEWEST” in the display column 82.

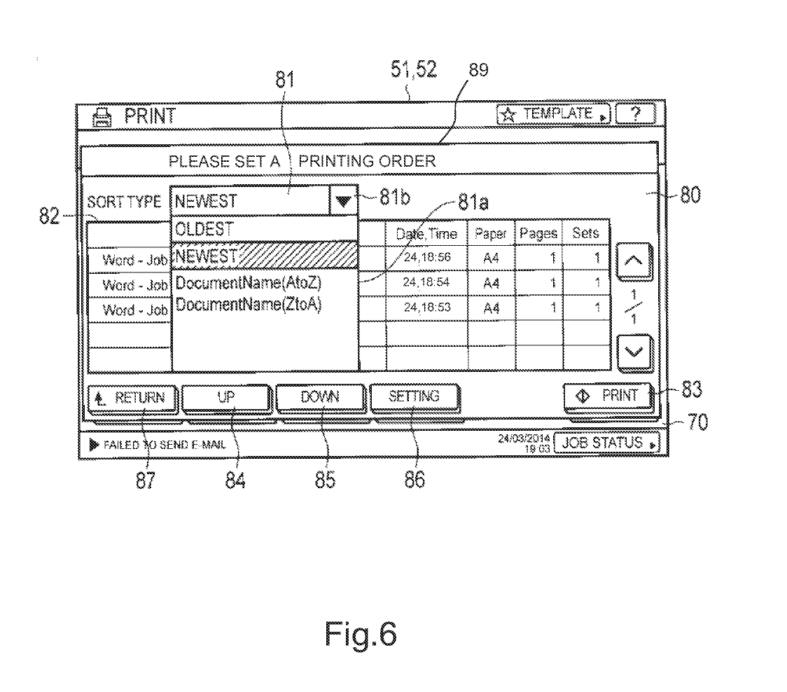

On the printing order setting screen 80 shown in FIG. 5, the panel control processor 61 detects a user touch with respect to a display part of a pulldown key 81b via the touch panel. Upon detecting the user touch, the panel control processor 61 controls the display unit 51 to display a sort type selection screen (list box 81a). FIG. 6 is a diagram showing the list box 81a on the printing order setting screen 80. The display unit 51 displays the list box 81a on the setting screen 80 as shown in FIG. 6. The list box 81a is a selection screen for selecting the sort type of the display order of the printing jobs (Word-Jobs A, B, and C) in the display column 82. The list box 81a includes a plurality of sort types as shown in FIG. 6. Examples of the sort type include an “OLDEST” type, a “Document Name (A to Z)” type, and a “Document Name (Z to A)” type in addition to the “NEWEST” type described above. In other words, 4 sort types are displayed in the list box 81a. Therefore, the user can operate the pulldown key 81b to display the list box 81a. The user can also select a desired sort type from the plurality of sort types displayed in the list box 81a.

The “NEWEST” type is a method of sorting the printing jobs from the newest registration time and date as described above.

The “OLDEST” type is a method of sorting the printing jobs from the oldest registration time and date.

The “Document Name (A to Z)” type is a method of sorting the printing jobs in an alphabetical order of document names (job names).

The “Document Name (Z to A)” type is a method of sorting the printing jobs in a reverse alphabetical order of the document names (job names).

The sort types displayed in the list box 81a are not limited to the types described above.

The panel control processor 61 detects a user touch with respect to the display parts of the sort types in the list box 81a via the touch panel. The panel control processor 61 detects the user touch and accepts the selection of the sort type. As shown in FIG. 6, upon accepting the selection of the sort type, the panel control processor 61 highlights the display part of the sort type. In other words, the highlighted sort type is a sort type that is being selected by the user.

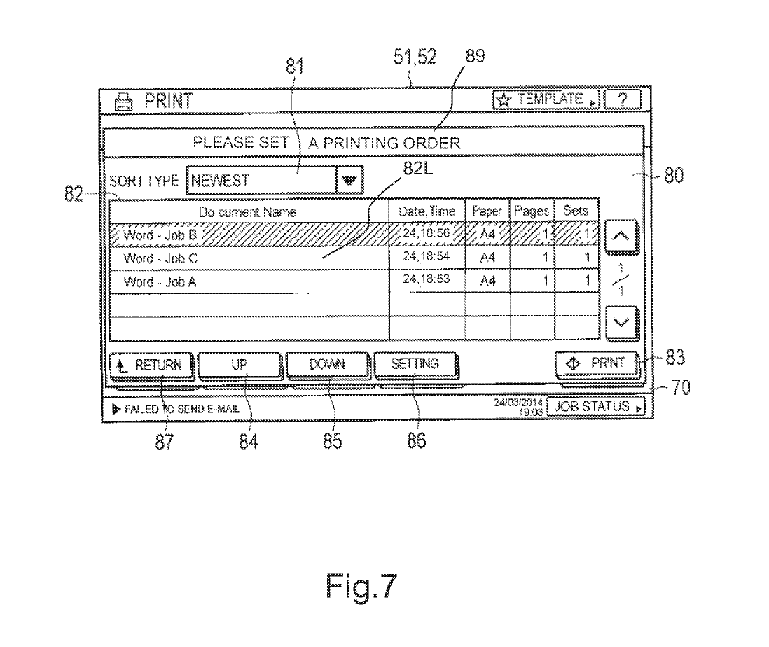

FIG. 7 is a diagram showing a display example of the setting screen 80 in a case where a printing order of a certain printing job is individually designated by the user. As shown in FIG. 7, the setting screen 80 includes the up button 84 and the down button 85. The up button 84 is a movement button that accepts an instruction of the user to move the display position (printing order) of the printing job that is being selected in the list 82L (“Word-Job B” in FIG. 7) one step higher in FIG. 7. The down button 85 is a movement button that accepts an instruction of the user to move the display position (printing order) of the printing job that is being selected in the list 82L one step lower in FIG. 7. The panel control processor 61 detects the user touch with respect to the display part of the up button 84 or the down button 85 via the touch panel. Upon detecting the user touch, the panel control processor 61 moves the display position of the printing job that is being selected one step lower or higher in the list 82L. Therefore, the user can operate the up button 84 or the down button 85 to individually change the display position (printing order) of the printing job that is being selected.

It should be noted that on the setting screen 80 shown in FIG. 7, the display position of the printing job that is being selected (“Word-Job B”) is the top position of the list 82L. In other words, the display position of the “Word-Job B” can only move downwardly in the list 82L. Therefore, the panel control processor 61 invalidates the up button 84 and validates only the down button 85.

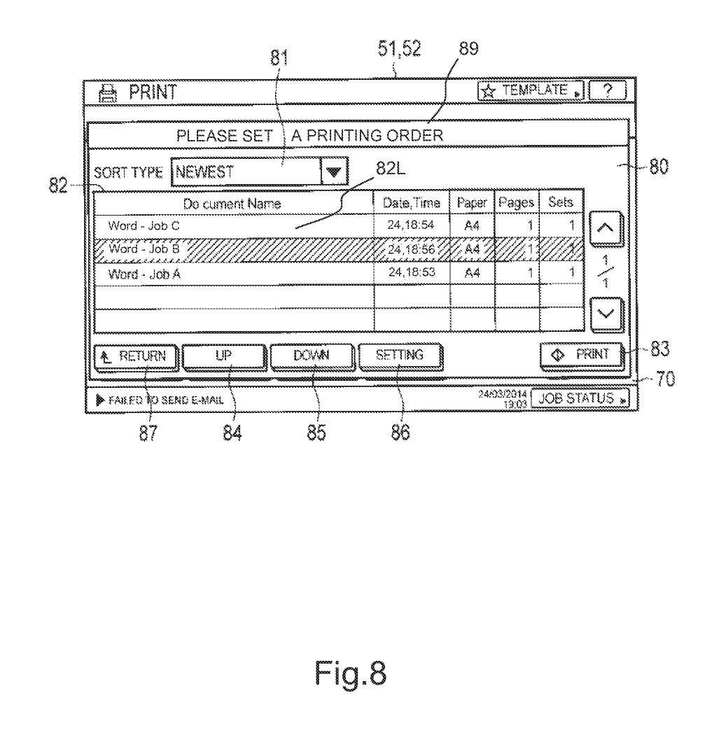

FIG. 8 is a display example in a case where the down button 85 is operated by the user on the setting screen 80 shown in FIG. 7. As shown in FIG. 8, the display position of the “Word-Job B” is second from the top in the list 82L. Specifically, as the down button 85 accepts an instruction of the user, the panel control processor 61 moves the display position of the printing job that is being selected one step lower in the list 82L. It should be noted that on the setting screen 80 shown in FIG. 8, the display position of the “Word-Job B” is movable in both the upward and downward directions in the list 82L. Therefore, the panel control processor 61 validates the up button 84 and the down button 85.

As shown in FIGS. 7 and 8, the setting screen 80 includes the setting button 86. The setting button 86 is a button that accepts an instruction of the user to display an output setting screen for a printing setting. The printing setting includes a setting for the finishing processing by the finisher 4, such as sorting of sheets in a set unit.

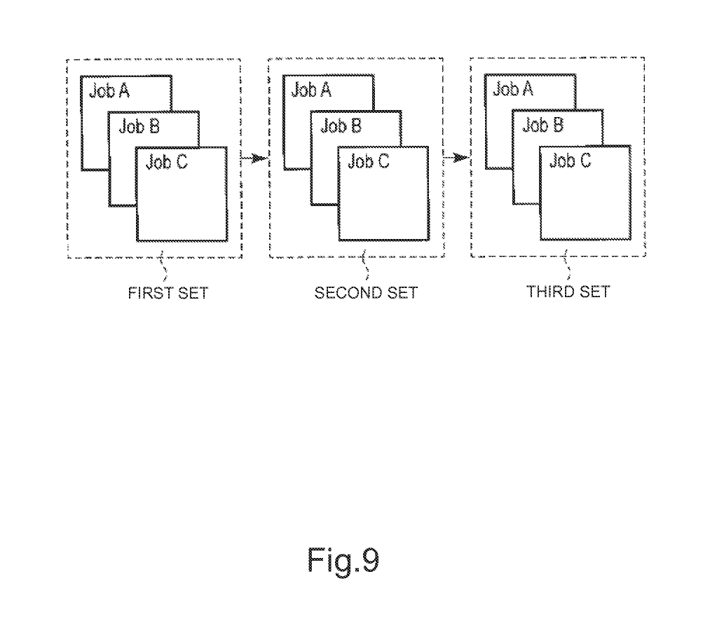

On the printing order setting screen 80, the panel control processor 61 detects a user touch with respect to the display part of the setting button 86 via the touch panel. Upon detecting the user touch, the panel control processor 61 displays the setting screen for the printing setting on the display unit 51. Therefore, the user can touch the setting button 86 to display the setting screen for the printing setting on the display unit 51. On the setting screen for the printing setting, the user can set the printing setting so that the printing order as that shown in FIG. 9 is obtained, for example. FIG. 9 is a diagram showing a result of printing three sets of printing jobs, each set including three printing jobs, in the display order (printing order) shown in FIG. 8. To obtain the printing result shown in FIG. 9, the processor 13 repeats, three times, the processing of sequentially printing the “Word-Job A”, “Word-Job B”, and “Word-Job C” one set at a time. In other words, as well as printing the plurality of printing jobs selected by the user in the printing order instructed by the user, the MFP 100 of this embodiment repetitively executes the printing for the number of times (number of sets) instructed by the user.

For example, as shown in FIG. 8, the printing order setting screen 80 also includes the print button 83 and the return button 87.

The print button 83 is a button that accepts an instruction of the user to execute printing of the selected printing jobs according to the instructed printing setting in the instructed printing order (display order). As the print button 83 accepts the instruction of the user, the panel control processor 61 outputs, to the job control processor 62, a printing execution instruction of the printing jobs based on the current setting content including the printing jobs being selected, the printing order, and the printing setting.

The return button 87 is a button that accepts an instruction of the user to return to the screen (e.g., selection screen 70 shown in FIG. 4) a step before the screen displayed on the display unit 51 (e.g., setting screen 80 shown in FIG. 8).

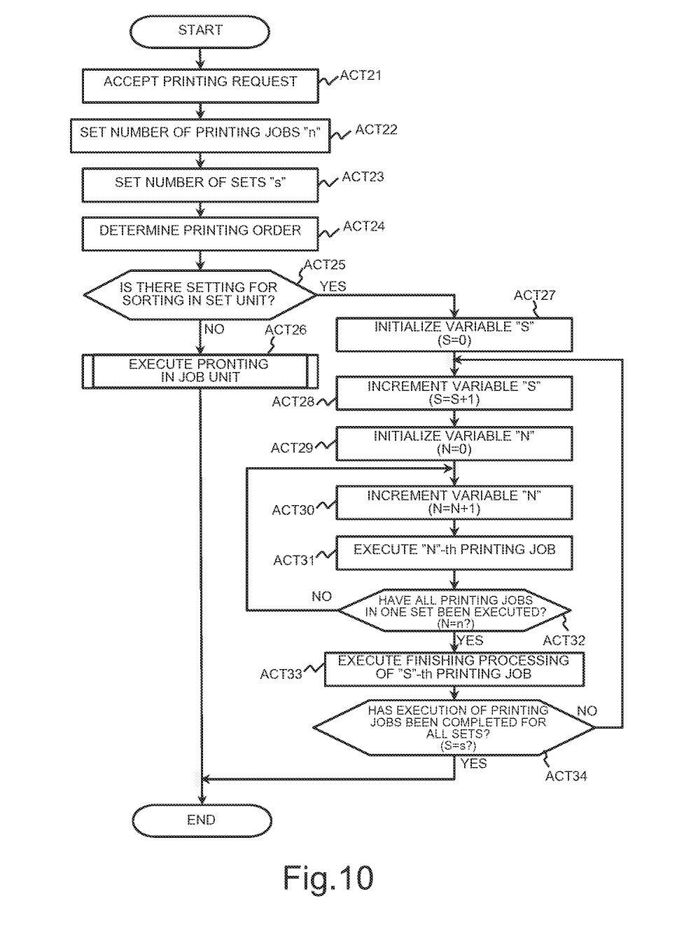

Next, the execution of printing jobs will be described with reference to FIG. 10. FIG. 10 is a flowchart for explaining a flow of the printing processing of printing jobs in the MFP 100.

The user selects a printing job to be printed via the operation panel 5 and instructs a printing setting such as the printing order. The user also operates the print button 83 to instruct to start printing.

When the user operates the print button 83, the panel control processor 61 accepts, in ACT21 of FIG. 10, a printing request from the user via the print button 83. As the panel control processor 61 accepts the printing request from the user, the processing of the MFP 100 advances to ACT22. In ACT22, the panel control processor 61 (processor 13) sets the number of printing jobs “n” selected by the user via the operation panel 5. As the panel control processor 61 sets the number of printing jobs “n”, the processing of the MFP 100 advances to ACT23. In ACT23, the panel control processor 61 sets the number of sets “s” selected by the user via the operation panel 5. As the panel control processor 61 sets the number of sets “s”, the processing of the MFP 100 advances to ACT24. In ACT24, when the print button 83 accepts the user operation, the panel control processor 61 determines the display order in which the printing jobs are displayed on the setting screen 80 as the printing order.

In addition, in ACT24, the panel control processor 61 arranges the job IDs of the printing jobs based on the determined printing order and creates a job ID list. The panel control processor 61 also creates information indicating the printing setting. The printing setting includes the setting for the finishing processing, such as a setting of the number of sets and a setting for sorting of the sheets in a set unit as described above. The panel control processor 61 outputs a printing execution instruction of the printing job to the job control processor 62 together with the job ID list and the information indicating the printing setting. As the job control processor 62 receives the printing execution instruction of the printing job, the processing of the MFP 100 advances to ACT25. In ACT25, the job control processor 62 judges whether there is a setting for the sorting of sheets in a set unit.

When judging that there is no setting for the sorting of sheets in a set unit in ACT25 (No in ACT25), the job control processor 62 outputs a printing execution instruction in a job unit to the printing execution control processor 63. As the printing execution control processor 63 receives the printing execution instruction in a job unit, the processing of the MFP 100 advances to ACT26. In ACT26, the printing execution control processor 63 executes printing based on the output of the printing execution instruction from the job control processor 62. For example, the job control processor 62 instructs the printing execution control processor 63 to execute printing in a job unit based on the job ID list arranged in the printing order. The printing execution control processor 63 executes printing based on the printing execution instructions sequentially output from the job control processor 62.

In addition, when judging that there is a setting for the sorting of sheets in a set unit in ACT25 (Yes in ACT25), the job control processor 62 sets various variables “S” and “N” for executing printing after sorting the sheets in a set unit. Specifically, when the job control processor 62 judges that there is a setting for the sorting of sheets in a set unit, the processing of the MFP 100 advances to ACT27. In ACT27, the job control processor 62 initializes the variable “S” (S=0). Further, in ACT28, the job control processor 62 increments the variable “S” (S=S+1). As the job control processor 62 increments the variable “S”, the processing of the MFP 100 advances to ACT29. In ACT29, the job control processor 62 initializes the variable “N” (N=0). Further, in ACT30, the job control processor 62 increments the variable “N” (N=N+1).

After the job control processor 62 increments the variable “N”, the processing of the MFP 100 advances to ACT31. In ACT31, the printing execution control processor 63 executes the “N”-th printing job in the job ID list. After the printing execution control processor 63 ends the execution of the “N”-th printing job, the processing of the MFP 100 advances to ACT32. In ACT32, the job control processor 62 judges whether all the printing jobs in one set have been executed. Specifically, the job control processor 62 judges whether the variable “N” is equal to the number of printing jobs “n”.

When judging that the variable “N” is not equal to the number of printing jobs “n” (No in ACT32), the job control processor 62 executes the processing of ACT30 to ACT32 again.

When the job control processor 62 judges that the variable “N” is equal to the number of printing jobs “n” (Yes in ACT32), the processing of the MFP 100 advances to ACT33. In ACT33, the printing execution control processor 63 executes the finishing processing of printing jobs in an “S”-th set. Specifically, every time the printer 3 completes the execution of the plurality of printing jobs of one set, the printing execution control processor 63 executes the finishing processing by the finisher 4 on the printing result. After the finishing processing, the processing of the MFP 100 advances to ACT34. In ACT34, the job control processor 62 judges whether the execution of printing jobs has been completed for all sets. Specifically, the job control processor 62 judges whether the variable “S” is equal to the number of sets “s”.

When judging that the variable “S” is not equal to the number of sets “s” (No in ACT34), the job control processor 62 executes the processing of ACT28 to ACT34 again. When judging that the variable “S” is equal to the number of sets “s” (Yes in ACT34), the job control processor 62 ends the series of processing assuming that the execution of printing jobs has been completed for all sets.

As described above, the image forming apparatus of this embodiment accepts a selection of a plurality of printing jobs by the user via the operation panel. The image forming apparatus also accepts an instruction of a printing order with respect to the plurality of selected printing jobs via the operation panel. The image forming apparatus causes the image forming unit to execute printing based on the plurality of printing jobs selected by the user in the printing order instructed by the user.

Therefore, according to the image forming apparatus of this embodiment, even when collectively executing a plurality of hold printing jobs or private printing jobs, the user can select a plurality of printing jobs and designate a printing order of the selected printing jobs.

Further, according to the image forming apparatus of this embodiment, the user can select the method of sorting the printing order of the plurality of printing jobs. The user can also sort the printing order of the printing jobs for each printing job. Furthermore, the user can also sort the printing order of the plurality of printing jobs in a unit of the number of sets to be printed.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form the methods and systems described herein may be made without departing from the sprit of the inventions. The accompanying claims and their equivalents are intended to cover such forms or modifications as would fall within the scope and spirit of the inventions.

What is claimed is:

1. An image forming apparatus, comprising:
an image forming unit that executes a printing job by forming an image on a recording medium;
a memory that stores a plurality of printing jobs not yet executed by the image forming unit;
an operation panel that accepts a selection of printing jobs to be executed from the plurality of printing jobs stored in the memory and a designation of an execution order of the selected printing jobs; and
a processor that causes the image forming unit to execute the printing jobs selected via the operation panel in the execution order designated via the operation panel.

2. The image forming apparatus according to claim 1,
wherein the operation panel includes a display unit that displays a selection screen for the printing jobs and a setting screen for the printing order with respect to the printing jobs, and
wherein the display unit displays the plurality of printing jobs stored in the memory on the selection screen and displays the plurality of printing jobs selected by a user on the setting screen.

3. The image forming apparatus according to claim 2,
wherein the operation panel accepts a selection of the printing jobs to be executed, that is made by the user, via the selection screen and accepts a designation of the printing order with respect to the selected printing jobs, that is made by the user, via the setting screen.

4. The image forming apparatus according to claim 3,
wherein a display order of the plurality of printing jobs displayed on the setting screen is the printing order of the printing jobs, and
wherein the operation panel accepts a designation of the user to sort the display order of the printing jobs via the setting screen.

5. The image forming apparatus according to claim 4,
wherein the operation panel accepts a designation to collectively change the display order of the plurality of printing jobs via the setting screen.

6. The image forming apparatus according to claim 5,
wherein the display unit displays a plurality of sorting methods for collectively changing the display order of the plurality of printing jobs displayed on the setting screen, and
wherein the operation panel accepts a selection of the sorting method via the setting screen.

7. The image forming apparatus according to claim 6,
wherein the plurality of sorting methods include a method of sorting the display order of the plurality of printing jobs in a name order of the printing jobs and a method of sorting the display order of the plurality of printing jobs in an order of time and dates at/on which the printing jobs have been stored in the memory.

8. The image forming apparatus according to claim 4,
wherein the operation panel accepts a designation to change a display order of a certain printing job out of the plurality of printing jobs via the setting screen.

9. The image forming apparatus according to claim 8,
wherein the display unit displays, on the setting screen, a movement button for changing a display position of a certain printing job out of the plurality of printing jobs displayed on the setting screen, and
wherein the operation panel accepts a selection of the certain printing job via the setting screen and accepts a designation to change the display order of the selected certain printing job via the movement button.

10. The image forming apparatus according to claim 1,
wherein the operation panel accepts, when printing of a plurality of sets, each including the plurality of selected printing jobs, is executed, a designation of the printing order of the printing jobs in a set unit via the setting screen.

11. The image forming apparatus according to claim 1,
wherein the processor creates a data list of the printing jobs in which pieces of data for specifying the printing jobs are arranged in the printing order, and causes the image forming unit to execute the selected printing jobs according to the created data list of the printing jobs.

12. An image forming method in an image forming apparatus including an image forming unit configured to execute a printing job by forming an image on a recording medium, a memory that stores a plurality of printing jobs not yet executed by the image forming unit, and an operation panel, the image forming method comprising:
accepting a selection of printing jobs to be executed from the plurality of printing jobs stored in the memory via the operation panel;
accepting a designation of an execution order of the selected printing jobs; and
causing the image forming unit to execute the selected printing jobs in the designated execution order.
